(19) United States
(12) Patent Application Publication
(10) Pub. No.: US 2020/0396079 A1
(43) Pub. Date: Dec. 17, 2020

(54) SYSTEM AND METHOD FOR SHARED SECRET ENCRYPTION AND VERIFICATION OF RECORDINGS OF MEETING PROCEEDINGS

(71) Applicant: QB Net Technology Inc., Vancouvwe BC (CA)

(72) Inventors: Henning DEKANT, Markham (CA); Scott Horlacher, Hamilton (CA)

(21) Appl. No.: 16/681,541

(22) Filed: Nov. 12, 2019

Related U.S. Application Data
(60) Provisional application No. 62/747,371, filed on Oct. 18, 2018.

(51) Int. Cl. H04L 9/32; H04L 9/06; H04L 9/08; H04L 29/06

(52) U.S. Cl. CPC H04L 9/3236; H04L 9/0643; H04L 9/083; H04L 2209/38; H04L 63/0435; H04L 63/0492; H04L 9/0825

(57) ABSTRACT

What is disclosed is a system to create meeting recordings using a first and a second user device coupled via a network to a blockchain, wherein the recordings are initiated at the first and second user devices, the initiation comprising coupling the first and second user devices using a first proximity communication; a symmetric key is established to encrypt and decrypt further proximity communications between the first and second user devices, and the further proximity communications comprise exchanging portions of data between the first and second user devices; a first signed package created at the first user device based on the portions of data and using a first hash; a second signed package created at the second user device based on the portions of data and using a second hash; and the first and second signed packages stored on the blockchain via the network.

### CROSS-REFERENCE TO RELATED APPLICATION

This application claims benefit to and priority of U.S. Provisional Patent Application No. 62/747,371, filed Oct. 18, 2018, the disclosures of which are incorporated by reference herein in their entirety.

### FIELD OF THE INVENTION

The present disclosure relates to recording meeting proceedings.

### BRIEF SUMMARY

A system to create recordings of a meeting is provided using a first and a second user device coupled via a network to a blockchain, wherein the recordings are initiated at the first and the second user device, the initiation comprising coupling the first and the second user device using a first proximity communication; a symmetric key is established, based on the initiation, to encrypt and decrypt further proximity communications between the first user device and the second user device, and the further proximity communications comprise exchanging one or more portions of data between the first user device and second user device; a first signed package created at the first user device based on the one or more portions of data and using a first hash; a second signed package created at the second user device based on the one or more portions of data and using a second hash; and the first and second signed packages stored on the blockchain via the network.

In a further embodiment, an application to enable creation of recordings of a meeting is provided using a first and a second user device, wherein the application is made available for installation on the first and the second user device; the application enables the first user device and the second user device to couple to a blockchain via a network; the application enables initiation of the recordings at the first user device and the second user device, the initiation comprising coupling the first and the second user device together using a first proximity communication; the application enables establishment, based on the initiation, of a symmetric key to encrypt and decrypt further proximity communications between the first and the second user device, and the further proximity communications comprise exchanging one or more portions of data between the first and the second user device; the application enables creation of a first signed package at the first user device based on the one or more portions of data and using a first hash; the application enables creation of a second signed package at the second user device based on the one or more portions of data and using a second hash; and the application enables storage of the first and second signed packages on the blockchain.

In a further embodiment, a method of creating recordings of a meeting is provided using a first and a second user device coupled via a network to a blockchain comprising initiating the recordings at the first and the second user device, the initiating comprising coupling the first and the second user device together using a first proximity communication; establishing, based on the initiating, a symmetric key to encrypt and decrypt further proximity communications between the first and the second user device, and the further proximity communications comprise exchanging one or more portions of data between the first user device and second user device; creating a first signed one or more portions of data at the first user device using a first hash; creating a second signed one or more portions of data at the second user device using a second hash; and storing the first and second signed one or more portions of data on the blockchain via the network.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1A is an illustration of a system to create a recording of a meeting.

FIG. 1B is an illustration of an embodiment of a user device.

FIG. 2 is an illustration of a blockchain.

FIGS. 3 and 4 is an illustration of a process for the operation of the meeting verification process.

FIGS. 5 and 6 is an illustration of a process to establish a symmetric key using a server.

FIGS. 7 and 8 is an illustration of a process to establish a symmetric key in a decentralized manner.

FIG. 9 illustrates an embodiment to create signed packages in parallel.

FIG. 10 illustrates an embodiment to create signed packages sequentially.

FIG. 11 illustrates an example embodiment for an offline mode of operation.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

A common problem encountered in hosting and administering meetings is verifying and recording the proceedings of the meeting. Typically the plurality of participants involved in the meeting will have their own opinions of what transpired during the meeting.

One way of overcoming this problem is by recording either video or audio versions of the meeting proceedings. However video or audio recordings may not necessarily be admissible in, for example, court or in other forums. Furthermore, there may be privacy concerns, as people may feel that they do not have control over the distribution of the video or audio recordings.

Therefore there is a need for systems and methods to obtain verification of audio and video recordings of meetings, as well as, for example, any accompanying documents and images, by all the participants. This is especially useful if, for example, a meeting was held to sign an agreement and verbally agreed upon changes were made before the agreement was signed.

The following details a system and method for verification of encrypted recordings of meeting proceedings using shared secrets that also safeguards and respects the privacy of all participants.

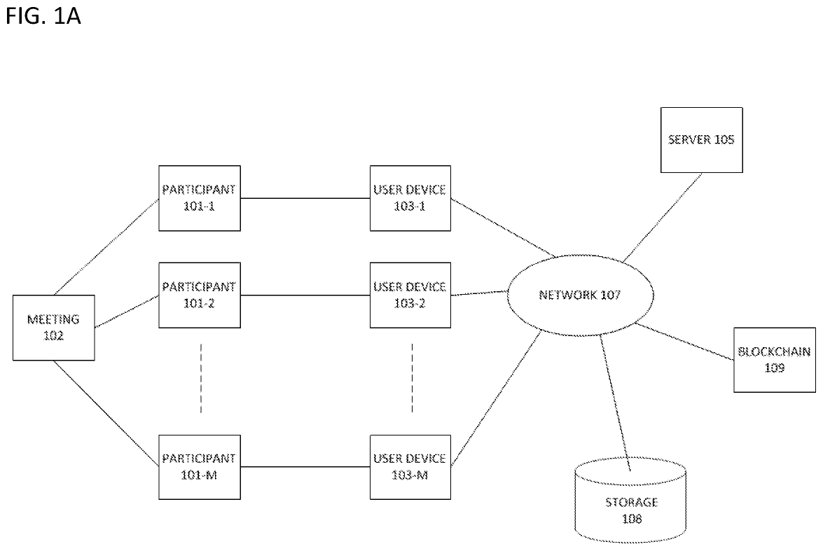

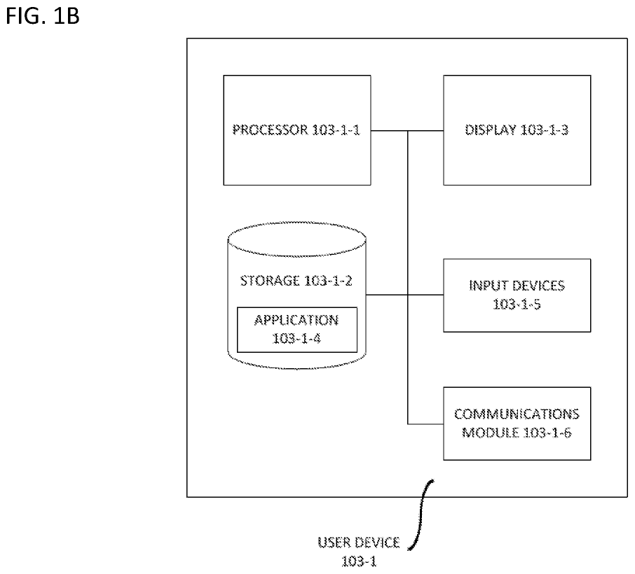

FIG. 1A shows an example illustration of a system for verification of encrypted recordings of meeting proceedings using shared secrets. In FIG. 1A, participants 101-1 to 101-M are attending meeting 102. A plurality of user devices 103-1 to 103-M, wherein each of said plurality of user devices corresponds to each of the participants 101-1 to 101-M, is also shown. The plurality of user devices 103-1 to 103-M comprises, for example, smartphones, laptops, tablet computers, wearable devices and other suitable computing devices.

The plurality of user devices 103-1 to 103-M is communicatively coupled to a server 105 via a network 107. Network 107 may be implemented in a variety of ways. For example, in one embodiment, network 107 comprises one or more subnetworks. In another embodiment, network 107 is implemented using one or more types of networks known to those of skill in the art. These types of networks include, for example, wireless networks, wired networks, Ethernet networks, local area networks, metropolitan area networks and optical networks. Additionally, network 107 interconnects other components of FIG. 1A such as storage 108, blockchain 109, server 105 and user devices 103-1 to 103-M together.

An embodiment of user device 103-1 is shown in FIG. 1B. Processor 103-1-1 performs processing functions and operations necessary for the operation of user device 103-1, using data and programs stored in storage 103-1-2. An example of such a program is application 103-1-4 which will be discussed in more detail below. Display 103-1-3 performs the function of displaying data and information for participant 101-1. Input devices 103-1-5 allow user 101 to enter information and perform, for example, audio and video recordings. This includes, for example, devices such as a touch screen, mouse, keypad, keyboard, microphone, camera, video camera and so-on. In one embodiment, display 103-1-3 is a touchscreen which means it is also part of input devices 103-1-5. Communications module 103-1-6 allows user device 103-1 to communicate with devices and networks external to user device 103-1. This includes, for example, communications via BLUETOOTH®, Wi-Fi, Near Field Communications (NFC), Radio Frequency Identification (RFID), 3G, Long Term Evolution (LTE), Universal Serial Bus (USB) and other protocols known to those of skill in the art. The components of user device 103-1 are coupled to each other as shown in FIG. 1B.

Referring back to FIG. 1A, recordings of meetings are stored in, for example, storage 108. Storage 108 is implemented using techniques known to those of skill in the art. In some embodiments, storage 108 comprises a database so as to appropriately allow for meetings to be indexed and tagged. In some embodiments, the database is searchable, and allows for search queries to be entered via an interface presented through, for example, an application or via a website. In further embodiments, data which is stored in storage 108 is encrypted. In further embodiments, the storage 108 is Write-Once Read-Many (WORM).

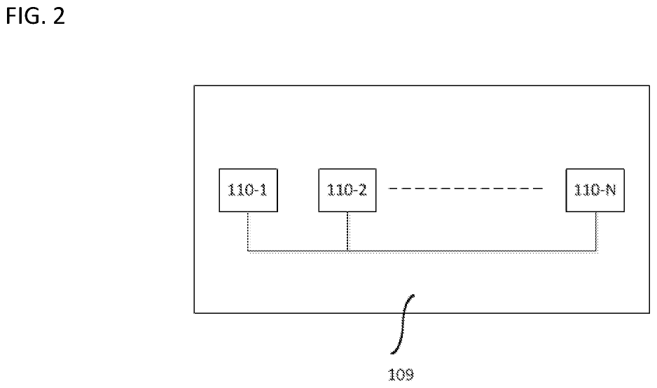

In one embodiment, the plurality of user devices 103-1 to 103-M is communicatively coupled to blockchain 109 via network 107. Blockchain 109 is used to improve the integrity of the system for meeting verification. A blockchain is a distributed computing architecture where every network node executes and records the same transactions, or individual user interactions with the blockchain. These transactions are secured by strong cryptographic techniques. The network nodes execute these transactions against one or more portions of previously submitted computer code termed smart contracts. The transactions for each node are grouped into blocks. Only one block can be added at a time, and every block can be provably verified to follow in sequence from the previous block. In this way, the blockchain's “distributed database” is kept in consensus across the whole network. Due to its architecture, a blockchain provides an immutable ledger or record. The blockchain 109 comprises a plurality of interconnected nodes 110-1, 110-2 to 110-N as shown in FIG. 2. Blockchain 109 is, for example, the Ethereum blockchain.

In some embodiments, the processes which are described below are implemented using an application or an “app” such as application 103-1-4 of FIG. 1B. The app is made available for downloading to and installation on the user devices from a source such as a server or a third party marketplace such as the GOOGLE® PLAY store or the APPLE® app store. Then, prior to usage, the app is downloaded to the user devices and installed on to the user devices. In further embodiments, the application enables the user devices to couple to the blockchain 109 via the network 107.

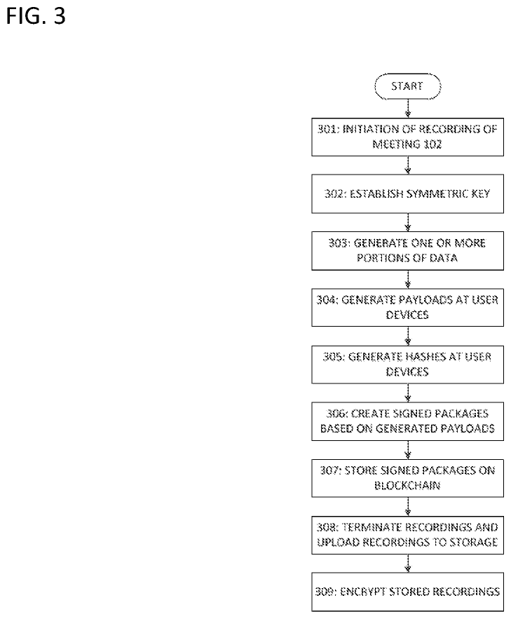

FIGS. 3 to 8 illustrate various embodiments for the operation of the meeting verification system 100 for user devices 103-1 to 103-M corresponding to participants 101-1 to 101-M.

In step 301 of FIG. 3, the user devices of the participants are used to initiate recordings of proceedings of meeting 102 at each of the user devices 103-1 to 103-M. The recordings comprise one or more of, for example:

audio recordings,

video recordings,

documents,

images, and

meeting notes.

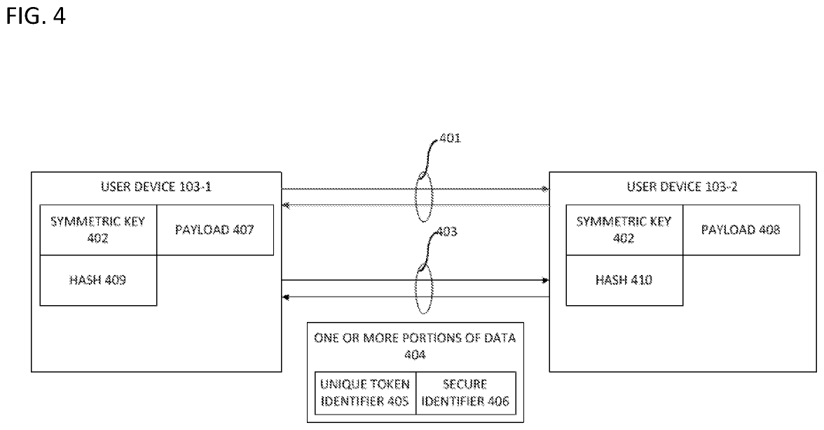

The recordings are performed using the recording devices which are part of, for example, input devices 103-1-5. In some embodiments, step 301 is implemented using an application such as application 103-1-4 of FIG. 1B running on the user devices. In some embodiments, the recording is initiated using a peer-to-peer proximity communication technique. This comprises the user devices coupling with each other using a first set of proximity communications so as to initiate the recording. An example is shown in FIG. 4 for participants 101-1 and 101-2 with associated user devices 103-1 and 103-2. User device 103-1 and user device 103-2 are coupled together using a first proximity communication 401. This is achieved by, for example, using application 103-1-4. Examples of proximity communications include bringing user device 103-1 and user device 103-2 together and using a Near Field Communications (NFC) protocol to couple the two user devices together. In some embodiments, this is achieved by having the participants place their corresponding user device within a common area such as the middle of a table. Then all the devices are coupled together using a first set of proximity communications, thereby forming a fully meshed ad hoc peer network.

A peer-to-peer proximity communication technique may face scalability issues. In some embodiments, a hub-and-spoke proximity communication technique is utilized to mitigate these scalability issues. In this technique, one of the user devices is selected to be the hub of an ad hoc mesh network, that is, all communications are routed through this hub. Then, the device which has been selected as the hub is coupled to server 105. The recording is initiated when all the other user devices couple to the hub device using a first set of proximity communications. In some embodiments, this is achieved by having each of the participants place their corresponding user device in proximity to the hub device. This is useful if, for example, there is difficulty connecting to the network 107 or server 105. In some embodiments, the hub device is selected based on, for example, one or more of:

connection speed,

random selection,

seniority of the user within a company, and

vote.

In further embodiments, connections to one or more of storage 108 and blockchain 109 are also performed via the hub device.

In some embodiments, the step 301 of initiating the recording is achieved by the user devices coupling to a server, such as server 105 of FIG. 1A. This may be achieved by, for example, having the application 103-1-4 generate a Uniform Resource Locator (URL) corresponding to the server, and transmitting messages such as emails or text messages or SMS messages comprising this URL to the user devices corresponding to the participants. Then, when the participants activate the URL, the recording is initiated by at least one of the user devices 103-1 to 103-M. In some embodiments, one or more of the user devices 103-1 to 103-M is nominated to perform the recording. For example, in the hub and spoke proximity communications method disclosed above, the hub device performs the recording.

In step 302, based on said initiation of step 301, shared secrets such as one or more symmetric keys are established for encryption and decryption of proximity communications between the user devices 103-1 to 103-M. In the embodiments where a first set of proximity communications is established to initiate the recording, the one or more symmetric keys are established for further sets of proximity communications.

An example is shown in FIG. 4, where a first proximity communication 401 is established between user devices 103-1 and 103-2. Then symmetric key 402 is established for further proximity communications 403 between user devices 103-1 and 103-2. In some embodiments, step 302 is implemented using an application such as application 103-1-4 of FIG. 1B running on both user device 103-1 and 103-2.

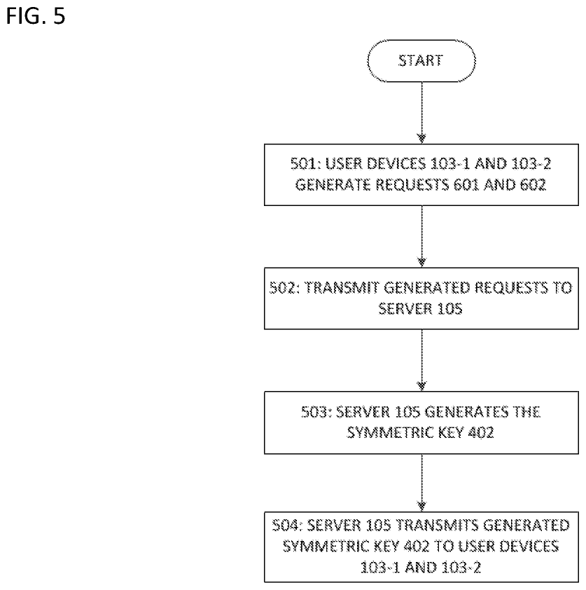

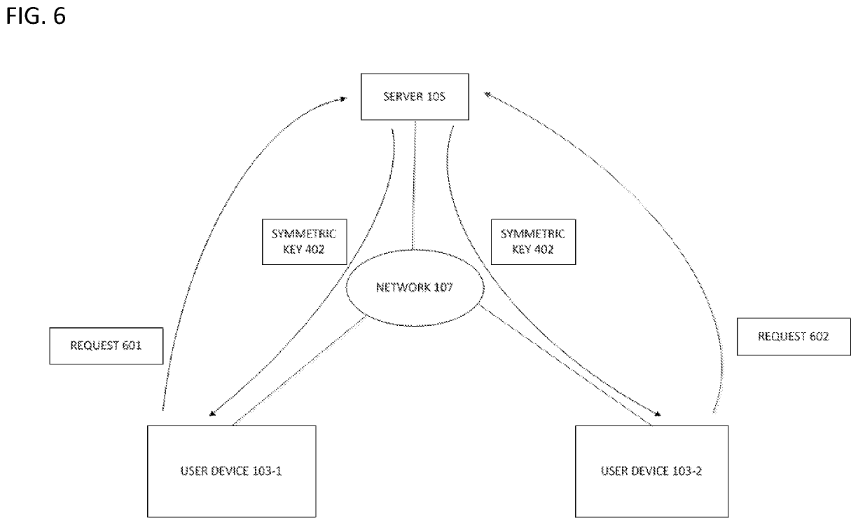

The one or more symmetric keys can be established in a variety of ways. In some embodiments, the one or more symmetric keys are established in a centralized manner, using, for example, server 105 of FIG. 1A. In some embodiments, the user devices 103-1 to 103-M generate and send requests to the server 105, which then generates a symmetric key and sends it to the user devices. An example process to establish a symmetric key for user devices 103-1 and 103-2 using server 105 is shown with reference to FIGS. 5 and 6. In step 501 of FIG. 5, user device 103-1 and user device 103-2 generate requests based on the initiation carried out in step 301 of FIG. 3. The requests 601 and 602 are shown in FIG. 6.

In step 502 of FIG. 5 the user devices 103-1 and 103-2 transmit the generated requests 601 and 602 to server 105 via network 107, as further illustrated in FIG. 6.

In step 503, server 105 generates the symmetric key 402 in response to receiving the requests 601 and 602 from user device 103-1 and 101-2.

In step 504, server 105 transmits the generated symmetric key 402 to user devices 103-1 and 103-2, as further illustrated in FIG. 6.

Other mechanisms can also be used such as the Rivest Shamir Adelman Key Encapsulation Mechanism (RSA-KEM) Key Transport Algorithm for the server to transmit the symmetric keys to the user devices.

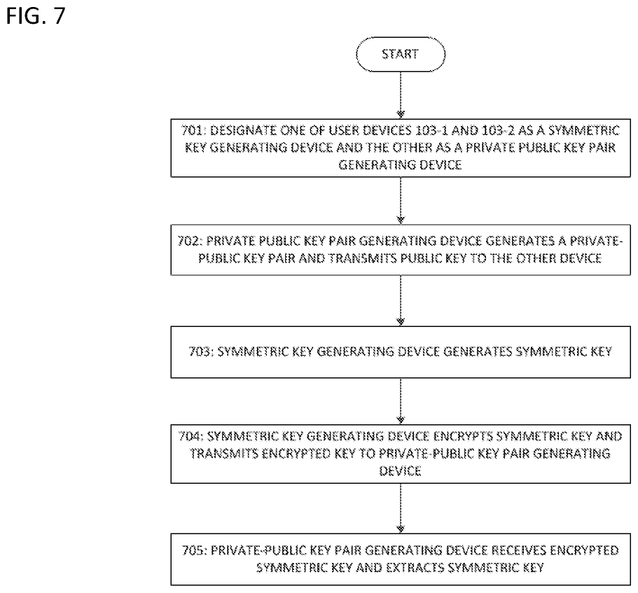

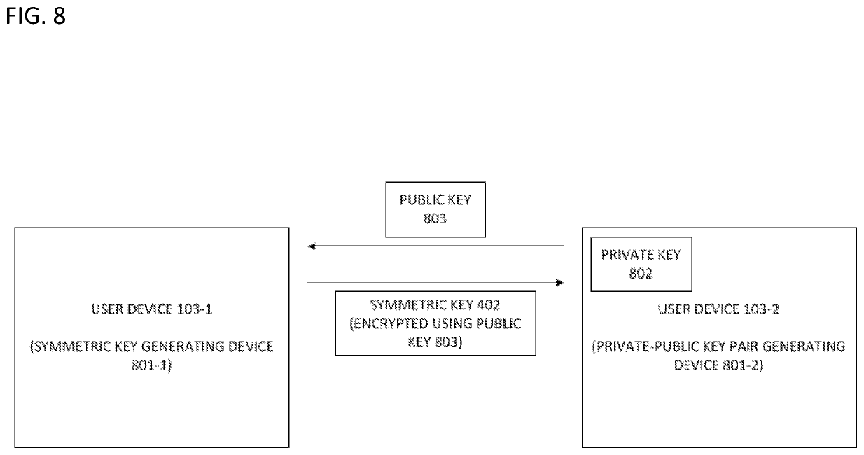

In other embodiments, the one or more symmetric keys are established in a decentralized manner by the user devices 103-1 to 103-M. In some embodiments, if the devices are using a peer-to-peer proximity communications technique, then for each pair of devices, one will be the symmetric key generating device and the other will be the private-public key pair generating device. In the case of a hub-and-spoke proximity communications technique, since the hub device is an endpoint for all communications: In some embodiments the hub device is the private-public key pair generating device, and the other devices are symmetric key generating devices. These terms will be explained below with reference to an example process for user devices 103-1 and 103-2 as shown in FIGS. 7 and 8. In step 701 of FIG. 7, one of the user devices 103-1 and 103-2 is designated as a symmetric key generating device; and the other is designated as a private-public key pair generating device. This designation is based on, for example,

random selection, or

priority selection based on, for example, the seniority of the associated participants.

For the purposes of this explanation, user device 103-1 is designated as the symmetric key generating device 801-1, and the other user device 103-2 is designated as the private-public key pair generating device 801-2. This is shown in FIG. 8 as well.

Then in step 702 and as also shown in FIG. 8, private-public key pair generating device 801-2 generates a private-public key pair (802, 803) and transmits public key 803 to user device 103-1.

In step 703 and as also shown in FIG. 8, symmetric key generating device 801-1 generates symmetric key 402 using, for example, a hashing of its Media Access Control (MAC) address.

In step 704 and as also shown in FIG. 8, symmetric key generating device 801-1 encrypts symmetric key 402 using public key 803 and transmits the encrypted symmetric key to private-public key pair generating device 801-2.

In step 705, private-public key pair generating device 801-2 receives the transmitted encrypted symmetric key, and decrypts the encrypted transmission using private key 802 to extract symmetric key 402.

In some embodiments, the processes described above and in FIGS. 5 to 8 are implemented using an application such as application 103-1-4 of FIG. 1B running on both user device 103-1 and 103-2.

Returning to FIGS. 3 and 4: In step 303, one or more portions of data for operation of the system 100 are generated by at least one of the user devices, encrypted using the one or more symmetric keys, and exchanged with the other user devices as part of the proximity communications. In some embodiments, the one or more portions of data comprise a unique token identifier and a secure identifier. In some embodiments, step 303 is implemented using an application such as application 103-1-4 of FIG. 1B.

An example is shown with reference to FIG. 4 for user devices 103-1 and 103-2. In FIG. 4, one or more portions of data 404 are generated by at least one of user devices 103-1 and 103-2, and exchanged with the other device as part of further proximity communications 403. In some embodiments, the one or more portions of data comprise unique token identifier 405 and secure identifier 406. In embodiments where there is a hub device and all communications are routed through the hub device, the exchange takes place at the hub device.

In step 304, payloads are generated at the user devices based on the exchanged one or more portions of data. In some embodiments, at least one portion of each of the generated payloads is identical. In other embodiments, the generated payloads comprise a unique token identifier and a secure identifier. In some embodiments, step 304 is implemented using an application such as application 103-1-4 of FIG. 1B running on the user devices.

An example is shown in FIG. 4. In FIG. 4 payloads 407 and 408 are generated at user devices 103-1 and 103-2 based on the exchanged one or more portions of data 404. In some embodiments, at least some portion of payloads 407 and 408 are identical to each other. In other embodiments, payloads 407 and 408 comprise unique token identifier 405 and secure identifier 406.

In the embodiments where there is a hub device and all communications are routed through the hub device, payloads are generated at the hub device and the other devices.

In step 305, hashes unique to each of the user devices are generated at the user devices. In some embodiments, step 305 is implemented using an application such as application 103-1-4 of FIG. 1B running on the user devices. For example, with reference to FIG. 4, unique hash 409 is generated at user device 103-1, and unique hash 410 is generated at user device 103-2. 103-1 and 103-2.

In step 306, these unique hashes are employed by each of the user devices to create signed packages based on the payloads. In some embodiments, step 306 is implemented using an application such as application 103-1-4 of FIG. 1B running on the user devices. For example in FIG. 4, hashes 409 and 410 are used to create signed packages 411 and 412 using payloads 407 and 408 respectively.

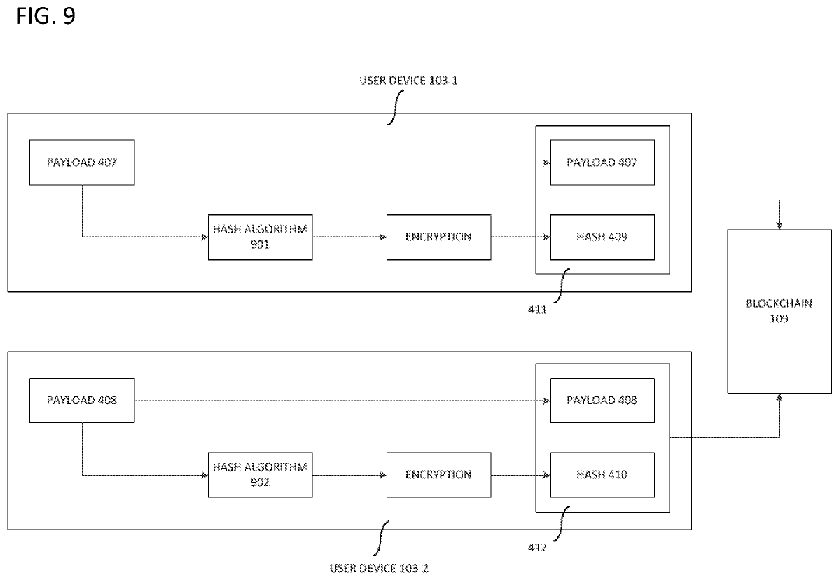

In some embodiments, signed packages are created in parallel, that is, each user device creates a signed package independently of the other user devices. An example is shown in FIG. 9. In FIG. 9, signed packages 411 and 412 are created in parallel. In FIG. 9, hash 409 is generated at user device 103-1 using payload 407. In some embodiments, other data unique to user device 103-1 is used together with payload 407 to generate hash 409 using hash algorithm 901. Then, hash 409 is encrypted using a key private and unique to user device 103-1 and combined with payload 407 to create signed package 411.

Similarly, hash 410 is generated at user device 103-2 using payload 408. In some embodiments, as with user device 103-1, other data unique to user device 103-2 is used together with payload 408 to generate hash 410 using hash algorithm 902. Then hash 410 is encrypted using a key which is private and unique to user device 103-2 and combined with payload 408 to create signed package 412. This occurs independently of user device 103-1.

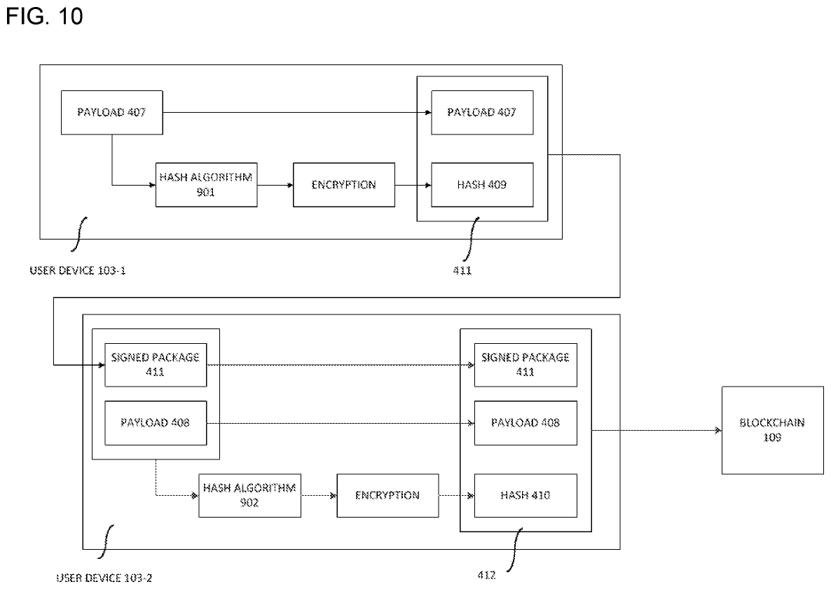

In some embodiments, the signed packages are created sequentially. This is shown in FIG. 10. In FIG. 10, signed package 411 is created as above. Then, signed package 411 is transmitted to user device 103-2 as part of further proximity communications 403. There, hash 410 is generated using a combination of signed package 411 and payload 408. Hash 410 is then aggregated together with the combination of signed package 411 and payload 408 to create signed package 412.

For the sequential creation embodiments, the sequence of creation of the signed packages by the user devices is also recorded. In the embodiments where there are more than two devices, a sequence must be selected. Then signatures are recorded in accordance with the sequence.

In step 307 in FIG. 3, the signed packages are stored on a blockchain such as blockchain 109. In the embodiments where parallel creation is employed, the signed packages are stored on blockchain 109 by the corresponding user devices. For example 411 and 412 are stored on blockchain 109 by user devices 103-1 and 103-2 as shown in FIG. 9. In the embodiments where sequential creation is employed, a signed package is stored on the blockchain 109 by the final device in the sequence. In some embodiments, the final device in sequence corresponds to the delegated user. For example, as shown in FIG. 10, signed package 412 is stored on the blockchain 109 by user device 103-2. For the sequential creation embodiments, the recorded sequence of creation of the signed packages by the user devices is stored. In some embodiments, step 307 is implemented using an application such as application 103-1-4 of FIG. 1B running on the user devices. In further embodiments, along with the one or more signed packages, a list of meeting participants and the number of meeting participants is included. The one or more signed packages are stored rather than the recording, as the size of the recording is substantially larger than the size of the one or more signed packages. This is because: As previously mentioned, every network node executes and records the same transactions, or individual user interactions with the blockchain. Therefore, user interaction with blockchain 109 to store the one or more signed packages imposes a smaller storage capacity burden on blockchain 109 as would storing the substantially larger entire recording.

Finally, in step 308 of FIG. 3, the recording of the meeting is terminated at the one or more user devices where recording was performed, and the recording is then uploaded from the one or more user devices where recording was performed to storage 108 via network 107 and server 105. There are various ways to terminate the recording. In some embodiments, the recording is terminated based on, for example, Global Positioning System (GPS) co-ordinates. In yet other embodiments, the recording is terminated based on user interaction with the application 103-1-4. In some example embodiments, the application presents a user interface with at least one control to terminate the recording, and the user may then activate the at least one control to terminate the recordings. In some embodiments, the recording is terminated only if all the users of the user devices where recording is being performed agree to terminate the recordings. This is enabled by, for example, the application running on each user device presenting a control to each user. In further embodiments, the recording is terminated by the application based on biometric inputs. Examples of biometric inputs include, for example, fingerprints, retinal scans and other biometric inputs known to those of skill in the art. Using biometric inputs provides certainty that the user terminated the recording.

In some embodiments, the recordings are terminated when the coupling represented by the first set of proximity communications is terminated. For example, with reference to FIG. 4, first proximity communication 401 is terminated. Then the recording is also terminated.

After the recording is terminated, the recordings are then uploaded from user devices 103-1 and 103-2 to storage 108 via network 107. In some embodiments, step 308 is implemented using an application such as application 103-1-4 of FIG. 1B running on the user devices.

In step 309 of FIG. 3, a recording encryption key is generated and then used to encrypt the uploaded one or more recordings in storage 108. The recording encryption key is generated using, for example, Advanced Encryption System (AES)

In some embodiments, the recording encryption key is generated by, for example, blockchain 109 based on the one or more signed packages stored in blockchain 109. In some embodiments the one or more signed packages are hashed using an in-built cryptographic hash functions stored within blockchain 109.

In other embodiments, the recording encryption key is generated based on the one or more recordings. In one embodiment, this recording encryption key is generated by, for example, server 105 or blockchain 109 based on a command sent by one of the devices which performed the recording.

The recording encryption key is stored in, for example, one of blockchain 109 or server 105. Access to the recording encryption key is regulated using, for example, a smart contract or a transactional Bitcoin message. In one embodiment, the recording encryption key is released when the number of participants that verify the signed package or packages is greater than or equal to a threshold. In some embodiments, this threshold is a majority threshold, that is, either:

(M/2) if M is even; or

(M/2) rounded up to the closest integer if M is odd.

In some embodiments, the threshold is a consensus threshold, that is, all participants who made recordings must verify the signed package or packages.

One of skill in the art would know that other thresholds are possible.

In order to verify the signed packages: In the case where parallel creation is employed, each device will

extract the encrypted hash from the corresponding package,

decrypt the extracted encrypted hash,

hash the payload, and

compare the decrypted hash with the hashed payload to determine if there is a match.

As previously mentioned above, in one embodiment, the recording encryption key is released when the number of participants that verify the signed packages is greater than or equal to a threshold, such as a majority threshold or a consensus threshold. Then the key which was used to encrypt the recordings is released by, for example, server 105 or blockchain 109, enabling the recording to be decrypted and downloaded. In some embodiments, this is implemented using an application such as application 103-1-4 of FIG. 1B running on the user devices.

In the case where sequential creation is employed, the sequence of creation of the signed packages by the user devices is made available to the participants. Extraction and verification occurs in the reverse order to that shown in the sequence. Then the last device in the sequence, which is the user device that created the final signed package before storage on the blockchain, performs the above process first to see if there is a match. Once there is a match, this user device
extracts the signed package sent to it by the next to last device in the sequence, which is the device which signed it previous to the current user device, and
sends the signed package to the next device in the sequence to determine if there is a match.

If all user devices record matches, then the key which was used to encrypt the recording is released, enabling the recordings to be decrypted and downloaded. In some embodiments, this is implemented using an application such as application 103-1-4 of FIG. 1B running on the user devices.

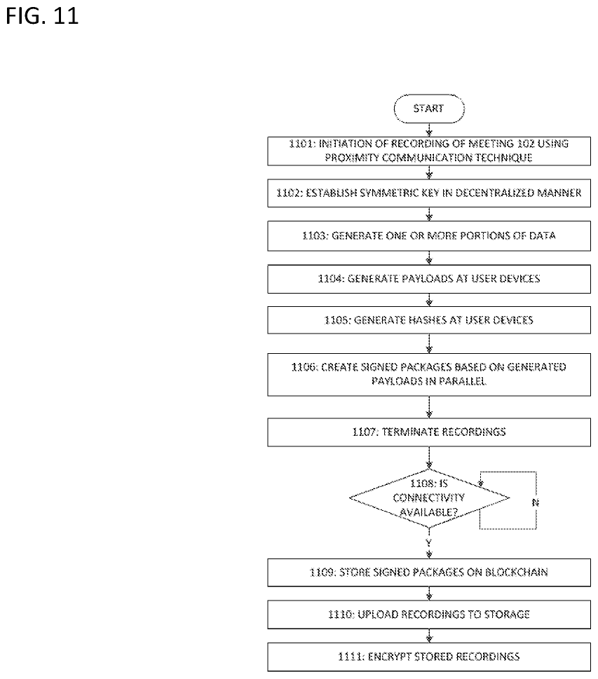

The system and method detailed above may also be implemented in an offline manner. This is useful, for example, in situations of intermittent or sporadic connectivity, or in areas which have little to no connectivity at all. Then, in some embodiments, an offline mode is defined. FIG. 11 shows an example embodiment for the offline mode. In the offline mode, with reference to FIG. 11:
In step 1101, recordings are initiated using, for example, a proximity communication technique such as a peer-to-peer or a hub-and-spoke proximity communication technique as detailed above;
In step 1102, the one or more symmetric keys are established in a decentralized manner;
Steps 1103-1105 are similar to steps 303-305 respectively and performed as detailed above;
In step 1106, the signed packages are created in parallel as detailed above;
In step 1107, the recordings are terminated using appropriate techniques detailed above;
If it is determined that there is connectivity available (step 1108), then
   In step 1109 the signed packages are stored on the blockchain,
   In step 1110 the recordings are uploaded to storage, and
   In step 1111 the recordings are encrypted with a key generated using the processes detailed above.

While the above has been described for a blockchain, one of skill in the art would realize that the above system and method can be generalized to other smart contract distributed systems.

One of skill in the art would appreciate that the above can be extended to the situation where one or more of the participants are remotely located and are conferencing into the meeting, for example, via teleconference or video conference over network 107. Then instead of proximity communications between the remotely located participants and the co-located participants, communications are performed using network 107 using techniques known to those of skill in the art.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A system to create recordings of a meeting using a first and a second user device coupled via a network to a blockchain, wherein:
the recordings are initiated at the first and the second user device,
the initiation comprising coupling the first and the second user device using a first proximity communication;
a symmetric key is established, based on the initiation, to encrypt and decrypt further proximity communications between the first user device and the second user device, and
the further proximity communications comprise exchanging one or more portions of data between the first user device and second user device;
a first signed package is created at the first user device based on the one or more portions of data and using a first hash;
a second signed package is created at the second user device based on the one or more portions of data and using a second hash; and
the first and second signed packages are stored on the blockchain via the network.

2. The system of claim 1 further comprising a server coupled to the network, wherein
the establishing of the symmetric key comprises
generation, based on the initiation, of a first request at the first user device and a second request at the second user device,
transmission of the generated first and second requests to the server via the network,
generation of the symmetric key by the server in response to receiving the first and second requests; and
transmission of the generated symmetric key to the first user device and the second user device.

3. The system of claim 1, further wherein the storing of the first and second signed packages on the blockchain is operative to create an immutable ledger.

4. The system of claim 1, wherein the creating of the first signed package and the creating of the second signed package occur sequentially.

5. The system of claim 1, wherein the creating of the first signed package occurs in parallel with the creating of the second signed package.

6. The system of claim 1, further wherein
the first and the second user device are coupled to a storage via the network;
the initiated recordings are terminated at the first and the second user device; and
the initiated recordings are uploaded to the storage via network.

7. The system of claim 6, further wherein a recording encryption key is generated and used to encrypt the uploaded recordings.

8. An application to enable creation of recordings of a meeting using a first and a second user device, wherein
the application is made available for installation on the first and the second user device;
the application enables the first user device and the second user device to couple to a blockchain via a network;
the application enables an initiation of the recordings at the first user device and the second user device,
the initiation comprising coupling the first and the second user device together using a first proximity communication;
the application enables an establishment, based on the initiation, of a symmetric key to encrypt and decrypt further proximity communications between the first and the second user device, and
the further proximity communications comprise exchanging one or more portions of data between the first and the second user device;
the application enables creation of a first signed package at the first user device based on the one or more portions of data and using a first hash;
the application enables creation of a second signed package at the second user device based on the one or more portions of data and using a second hash; and
the application enables storage of the first and second signed packages on the blockchain.

9. The application of claim 8 further wherein the first user device and the second user device are coupled to a server via the network; and
the establishment of the symmetric key comprises
generation, based on the initiation, of a first request at the first user device and a second request at the second user device,
transmission of the generated first and second requests to the server via the network,
generation of the symmetric key by the server in response to receiving the first and second requests; and
transmission of the generated symmetric key to the first user device and the second user device.

10. The application of claim 8, further wherein
the first user device is a symmetric key generating device,
the symmetric key generating device has a public key, and
the second device has a private key; and
the establishment of the symmetric key comprises
generation of the symmetric key by the symmetric key generating device,
encryption of the symmetric key by the symmetric key generating device using the public key prior to transmission to the second device, and
decryption of the encrypted symmetric key by the second device using the private key after receipt by the second device.

11. The application of claim 8, wherein the creating of the first signed package. occurs in parallel with the creating of the second signed package.

12. The application of claim 11, wherein access to a recording encryption key is based on meeting a threshold related to verification of the first and the second signed packages.

13. The application of claim 8, further wherein
the first user device and the second user device are coupled to a storage via the network;
the initiated recordings are terminated at the first user device and the second user device; and
the initiated recordings are uploaded to the storage via network.

14. The application of claim 8, further wherein a determination of availability of connectivity is made.

15. A method of creating recordings of a meeting using a first and a second user device coupled via a network to a blockchain comprising
initiating the recordings at the first and the second user device,
the initiating comprising coupling the first and the second user device together using a first proximity communication;
establishing, based on the initiating, a symmetric key to encrypt and decrypt further proximity communications between the first and the second user device, and
the further proximity communications comprise exchanging one or more portions of data between the first user device and second user device;
creating a first signed one or more portions of data at the first user device using a first hash;
creating a second signed one or more portions of data at the second user device using a second hash; and
storing the first and second signed one or more portions of data on the blockchain via the network.

16. The method of claim 15 further wherein the first user device and the second user device are coupled to a server via the network; and
the establishing of the symmetric key comprises
generating, based on the initiation, a first request at the first user device and a second request at the second user device,
transmitting the generated first and second requests to the server via the network,
generating, by the server in response to receiving the first and second requests, the symmetric key; and
transmitting, by the server, the generated symmetric key to the first user device and the second user device.

17. The method of claim 15, further wherein
the first user device is a symmetric key generating device,
the symmetric key generating device has a public key, and
the second user device has a private key; and
the establishing of the symmetric key comprises
generating, by the symmetric key generating device, the symmetric key,
encrypting the symmetric key by the symmetric key generating device using the public key prior to transmission to the second device, and
decrypting the encrypted symmetric key by the second device using the private key after receipt by the other device.

18. The method of claim 15, wherein the creating of the first signed package and the creating of the second signed package occur in a sequence.

19. The method of claim 18, wherein the sequence is recorded and used in verification of the first and the second signed packages.

20. The method of claim 15, further wherein the first and the second user device are coupled to a storage via the network, the method further comprising
terminating the initiated recordings at the first and the second user device;
uploading the initiated recordings to the storage via network; and
the storing of the first and second signed packages on the blockchain is operative to create an immutable record.
